(19) United States
(12) Patent Application Publication
(10) Pub. No.: US 2012/0224261 A1
(43) Pub. Date: Sep. 6, 2012

(54) ADJUSTABLE OPTICAL ASSEMBLY AND METHOD

(75) Inventors: Henry A. Greene, Durham, NC (US); Robert Carlton Lynch, Fuquay Varina, NC (US)

(73) Assignee: Ocutech, Inc.

(21) Appl. No.: 13/412,268

(22) Filed: Mar. 5, 2012

Related U.S. Application Data
(60) Provisional application No. 61/449,657, filed on Mar. 5, 2011.

(51) Int. Cl. G02B 7/02

(52) U.S. Cl. 359/481; 359/816

(57) ABSTRACT

An optical support assembly including at least one optical assembly, a bracket adapted for coupling to a spectacle frame, and a rail frame coupled to the bracket and comprising any of (1) a rigid rail frame engaged to the at least one optical assembly for laterally adjusting said at least one optical assembly, and (2) a deformable rail frame engaged to the at least one optical assembly for manual reconfiguring said at least one optical assembly.

### RELATED APPLICATIONS

This application claims priority to U.S. Provisional Patent Application No. 61/449,657, filed Mar. 5, 2011, the disclosure of which is incorporated by reference herein in its entirety.

### FIELD OF THE INVENTION

This invention relates generally to adjustable optical assemblies and methods of adjusting optical assemblies.

### BACKGROUND

Vision enhancing devices (i.e., optical assemblies) facilitate magnifying and/or focusing on visual objects selected by a user. Optical assemblies are used by a variety of people for a variety of purposes. Such individuals and purposes include, but are not limited to, low vision individuals, people engaged in detailed work generally in professional fields (e.g., surgeons, dentists, gemologists, researchers, and archeologists), and individuals using such devices for entertainment, recreational, and sporting purposes (e.g., hunting and spectator sports). Optical assemblies may be described as binoculars, bioptics, vision aids, telescopes, or loupes.

Many optical assemblies are mounted into a lens of a spectacle (e.g., eye glasses or sun glasses). Mounting optical assemblies into a lens is an expensive and time-consuming process that results in a device that is generally not adjustable. For instance, positioning and creating the holes in the lens for a particular individual requires precision in measurement along with accurate drilling/cutting of the lens, a process that may necessitate a specialized off-site lab and delay of days or even weeks.

Other optical assemblies are adapted for mounting to a spectacle. Such devices, however, often cannot be adjusted or have bulky and/or heavy components.

In consequence, the art continues to seek improvements in lightweight and adjustable optical assemblies that are less expensive and less time-consuming to align, position, and manufacture.

### SUMMARY

Embodiments of this invention relate to an optical support assembly including an adjustable optical assembly, along with a method of adjusting an optical assembly.

In one aspect, embodiments of the invention relate to an optical support assembly comprising: at least one optical assembly; a bracket adapted for coupling to a spectacle frame; and a rail frame coupled to the bracket and comprising any of (1) a rigid rail frame engaged to the at least one optical assembly for laterally adjusting said at least one optical assembly, and (2) a deformable rail frame engaged to the at least one optical assembly for manual reconfiguring said at least one optical assembly.

In another aspect, embodiments of the invention relate to a method of adjusting an optical assembly, the method including coupling an optical support assembly to a spectacle frame, the optical support assembly including (a) at least one optical assembly, (b) a bracket adapted for coupling to a spectacle frame, and (c) a rail frame coupled to the bracket and comprising any of (1) a rigid rail frame engaged to the at least one optical assembly for laterally adjusting said at least one optical assembly, and (2) a deformable rail frame engaged to the at least one optical assembly for manual reconfiguring said at least one optical assembly; and positioning the at least one optical assembly.

Other aspects, features and embodiments of the invention will be more fully apparent from the ensuing specification and claims.

### BRIEF DESCRIPTION OF THE FIGURES

FIG. 1 is a perspective view of an optical support assembly coupled to a spectacle frame according to some embodiments.

FIG. 2 is a perspective view of the optical support assembly coupled to a spectacle frame of FIG. 1 with the optical support assembly pivoted away from a viewing angle.

FIG. 3 is a partially exploded perspective view of the optical support assembly of FIG. 1 according to some embodiments.

FIG. 4 is a perspective view of a portion of a bracket and mount of the optical support assembly of FIG. 1 according to some embodiments.

FIG. 5A is a schematic illustration of a portion of the bracket of FIG. 4 according to some embodiments.

FIG. 5B is a schematic illustration of a portion of the bracket of FIG. 4 according to some other embodiments.

### DETAILED DESCRIPTION OF EMBODIMENTS OF THE INVENTION

The invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

As used herein, the terms “comprising” or “comprises,” “including” or “includes,” and “having” or “has” are open-ended, and include one or more stated features, integers, elements, steps, components or functions but does not preclude the presence or addition of one or more other features, integers, elements, steps, components, functions or groups thereof. As used herein, the term “and/or” includes any and all combinations of one or more of the associated listed items.

As used herein, the common abbreviation “e.g.,” which derives from the Latin phrase “exempli gratia,” may be used to introduce or specify a general example or examples of a previously mentioned item, and is not intended to be limiting of such item. If used herein, the common abbreviation “i.e.,” which derives from the Latin phrase “id est,” may be used to specify a particular item from a more general recitation.

The terminology used herein is for the purpose of describing particular embodiments only and is not intended to be limiting of the invention. As used herein, the singular forms “a,” “an” and “the” are intended to include the plural forms as well, unless the context clearly indicates otherwise.

Well-known functions or constructions may not be described in detail for brevity and/or clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, spatially relative terms, such as “under,” “below,” “lower,” “over,” “upper,” “downward,” “upward,” “inward, “outward” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below

The term “rail frame” as used herein refers to a member adapted to support an optical assembly and allow traversal along a portion thereof. In various embodiments, a rail frame comprises a rigid rail frame that may include any of a relatively hardened cable, a shaped bar member, a thin shaft assembly, and a relatively rigid wire. In other embodiments, a rail frame comprises a deformable rail frame that may include any of a relatively flexible wire (e.g., having sufficient structural integrity to hold its shape and the weight of an optical assembly counter to gravity), memory metal, and the like. A rail frame may comprise a singular member or multiple members. A rail frame in one embodiment is a singular shaped elongate member that creates a looped frame extending from at least one side of a bracket and/or a mount, wherein the top and bottom portions of the looped frame are substantially parallel to allow slidable engagement by an optical assembly having a height comparable to the distance between the substantially parallel top and bottom portions of the looped frame. The rigid rail frame may be made from any type of material sufficient to retain its shape and support an optical assembly, but yet be relatively lightweight. Such materials may include extruded plastics, polymers, and lightweight metal wiring or cable that resists bending following manufacture. The deformable rail frame may allow for manually positioning an optical assembly in any desired position.

Embodiments of the invention relate to optical support assemblies including adjustable optical assemblies, along with methods of adjusting optical assemblies.

In one embodiment, an optical support assembly is disclosed that comprises at least one optical assembly, a bracket adapted for coupling to a spectacle frame, and a rail frame coupled to the bracket and comprising any of (1) a rigid rail frame engaged to the at least one optical assembly for lateral adjusting said at least one optical assembly, and (2) a deformable rail frame engaged to the at least one optical assembly for manual reconfiguring said at least one optical assembly.

In various embodiments, an optical support assembly includes a bracket adapted for coupling to a spectacle frame. The bracket may be of any type known in the art that is capable of being secured to a spectacle frame, yet which provides coupling with a rail frame. The bracket may include a pivot member and/or a pivotable member for pivotally translating the rail frame and optical assembly into a viewing position (e.g., a position in which the optical assembly is aligned with the spectacle lens so as to enable a spectacle wearer to view the spectacle lens and optical assembly in a line of sight manner) or away from a viewing angle (e.g., pivoted or flipped up and therefore not in the line of sight of a viewer looking through the lenses of the spectacles).

In various embodiments, a rotational adjustment mechanism is provided for rotating the rail frame about the bracket. In one embodiment, the rotational adjustment mechanism comprises (a) a mount coupled to the rail frame, and (b) an axle member arranged to (i) traverse an opening in the mount and (ii) couple the mount to the bracket, and wherein the rail frame may be rotated about an axis relatively parallel with the axle member. Rotational movement provides an additional degree of adjustment for an optical assembly engaged with a rail frame. The axle member may comprise, for example, a pin, screw, cotter key, or elongated fastener, wherein such axle member is arranged for traversing an opening in the mount. The mount may be a plate on the exterior of the bracket that includes an opening through which may be aligned with an opening, recess, or throughway on at least a portion of the bracket.

In one embodiment, the axle member of the rotational adjustment mechanism is a screw adapted to engage threads in the bracket. In the use of such an axle member, the screw is loosened sufficiently to allow the mount to be loosened from the bracket for rotation about the screw and axis thereof. In another embodiment, at least a portion of the bracket comprises a slotted throughway adapted to allow traversal of the axle member and rotation about such axle (wherein such embodiment combines a rotational adjustment mechanism with a vertical adjustment mechanism). In addition to rotation, the axle may be loosened and/or repositioned along any portion of the slotted throughway to allow movement (e.g., vertical) of the axle, mount, and attached rail frame.

In various embodiments, a vertical adjustment mechanism is disclosed as being integrated with the bracket for vertical movement of the rail frame and the at least one optical assembly. In one embodiment, vertical adjustment mechanism comprises (a) a mount coupled to the rail frame, and (b) an axle member arranged to traverse (i) an opening in the mount and (ii) a slotted throughway in at least a portion of the bracket. The slotted throughway in this embodiment is vertical relative to the spectacles, which provides for vertical movement of the traversing axle member, mount, and rail frame coupled to the mount. The axle member may comprise any of a pin, screw, cotter key, and elongated fastener.

In a specific embodiment, the vertical adjustment mechanism further comprises a nut comprising threads adapted to engage a screw, wherein an exterior of the nut is arranged to allow traversal of the nut through the slotted throughway but inhibit rotational movement of the nut. Such rotational movement of the nut may be inhibited with a nut comprising an elongated shape comparable to (but less than) the width of the slotted throughway, but less than the length of the slotted throughway so that the nut may traverse the interior of the slotted throughway.

While the optical assembly may be adapted to slidably engage the rail frame for lateral adjustment thereof, once the optical assembly is in place, a securing mechanism may be utilized in various embodiments to maintain the fixed position. In various embodiments, the securing mechanism is any of a screw, clamp, cam lock, tension mechanism, and caliper. The securing mechanism may be incorporated with the housing or locking cap (or both) of the optical assembly. In one embodiment, a tab, button, or similar instrument may be used to engage the securing mechanism with the rail frame for fixed engagement thereto.

In various embodiments, the optical assembly comprises a housing adapted to enclose a magnifying and/or focusing lens or lenses. The housing may include one or more recesses (e.g., generally at least two recesses when two substantially parallel rails are utilized) that complement the shape of the rail frame to allow smooth lateral traversal about the rail frame. To secure the housing to the rail frame without locking it in a fixed position, a locking cap may be provided that fits over one end of the housing, encasing the rail frame between the housing and locking cap, so that the optical assembly (including the housing and locking cap) will be retained on the rail frame.

To further ensure the optical assembly is retained on the rail frame, the rail frame may comprise a single rail that makes a rectangularly shaped loop from the bracket to one lateral end distal from the bracket and/or the mount and back to the bracket and/or the mount. Such a rail may form top and bottom portions of the rail frame that are parallel relative to one another. The two parallel portions of the rail frame secure the top and bottom of one end of the optical assembly (thereby providing greater structural integrity). The distal loop portion of the rail frame also precludes the optical assembly from being slipped off of the distal end. Therefore, in various embodiments herein, one way to attach an optical assembly to a rail frame is to fit the housing within the parallel rails (proximate recesses in the housing adapted to accept and guide the housing and locking cap along the rail frame), place the locking cap over the rails and housing, and secure the locking cap to the one end of the housing proximate the rail frame. The locking cap may also include one or more recesses (e.g., generally at least two when two substantially parallel rails are utilized).

In another aspect, embodiments of the invention relate to a method of adjusting an optical assembly, the method including coupling an optical support assembly to a spectacle frame, the optical support assembly including (a) at least one optical assembly, (b) a bracket adapted for coupling to a spectacle frame, and (c) a rail frame coupled to the bracket and comprising any of (1) a rigid rail frame engaged to the at least one optical assembly for lateral adjusting said at least one optical assembly, and (2) a deformable rail frame engaged to the at least one optical assembly for manual reconfiguring said at least one optical assembly; and positioning the at least one optical assembly.

The advantages and features of the disclosure are further illustrated with reference to the following example, which is not to be construed as in any way limiting the scope of the invention but rather as illustrative of one embodiment of the invention in a specific application thereof.

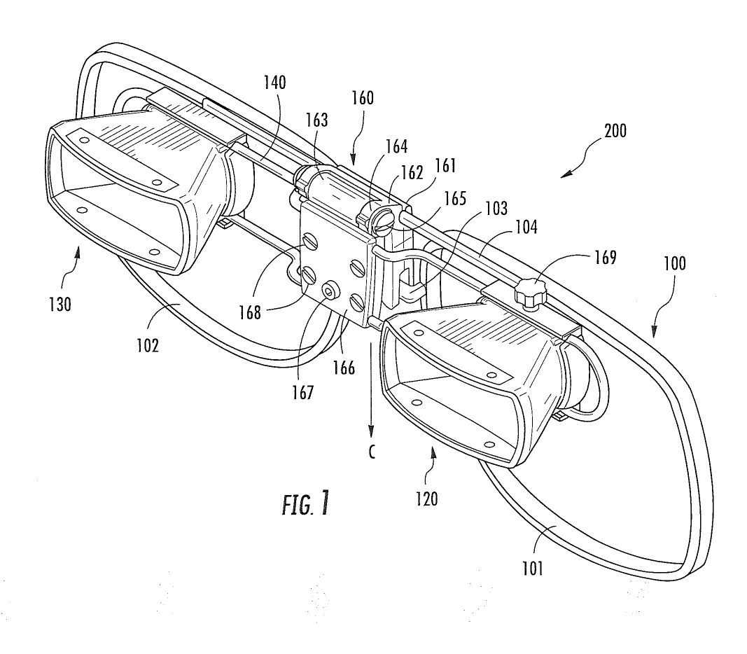

FIG. 1 discloses an optical support assembly 200 coupled to a spectacle frame 100. The optical support assembly 200 includes a left optical assembly 120 and a right optical assembly 130, one for each eye from the viewer's angle (the optical support assembly may be adapted with only one optical assembly as desired). The optical support assembly 200 also includes a rail frame 140 attached to a mount 166 by one or more fasteners such as screws 168, wherein the mount 166 is coupled to a bracket 160. The bracket 160 couples the entire assembly 200 to a top bridge 104 and/or bottom bridge 103 of the spectacle frame 100. The bracket 160 may be adapted to attach to any type of spectacle having any number of bridges, shape, or configuration.

In FIG. 1, the bracket 160 includes a first plate 161 on one side of the spectacle bridges 103 and 104 and a second plate 162 on the opposite side of the spectacle bridges 103 and 104, wherein the two opposing plates 161 and 162 may be secured in any manner known in the art. For example, the first and second plates 161, 162 may be secured by and/or coupled to a generally u-shaped member 164. A pivotable member 163 extends between the member 164 and is attached thereto by a pivot member 165 such as a screw, pin or any other pivot member known to those of skill in the art.

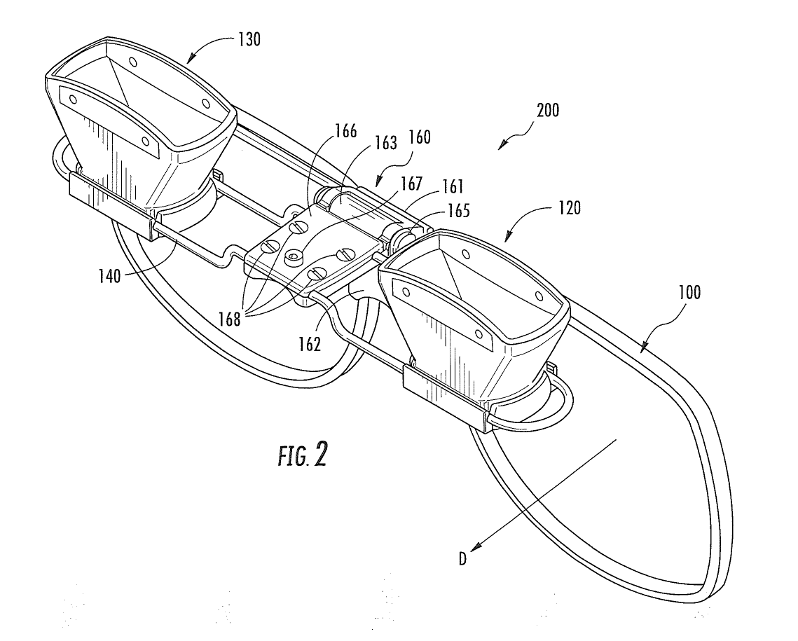

The position of the rail frame and support assembly is in a viewing angle in FIG. 1, and pivoted away from a viewing angle in FIG. 2, wherein the viewing angle is represented by an arrow D in FIG. 2. Therefore, FIG. 1 represents a position with the right optical assembly 130 at least partially in the line of sight created by the right (from the position of the person wearing the spectacles 100) spectacle eye frame 102 and with the left optical assembly 130 at least partially in the line of sight created by the left (from the position of the person wearing the spectacles 100) spectacle eye frame 101.

Also disclosed is a portion of a rotational adjustment mechanism in the form of an axle 167 (such as a threaded screw) that allows rotational movement of the mount 166 about an axis parallel with the axle 167. The same axle 167 may provide a portion of the vertical adjustment mechanism to allow movement from the current position down in the direction C and back again.

Referring to FIG. 4, the generally u-shaped member 164 is shown with a rotatable member 163′ pivotally connected thereto. A mount 166′ resides on top of the rotatable member 163′ and may be adjusted vertically relative thereto in the directions C. The mount 166′ may also be rotated relative to the rotatable member 163′ as shown by the arrow E.

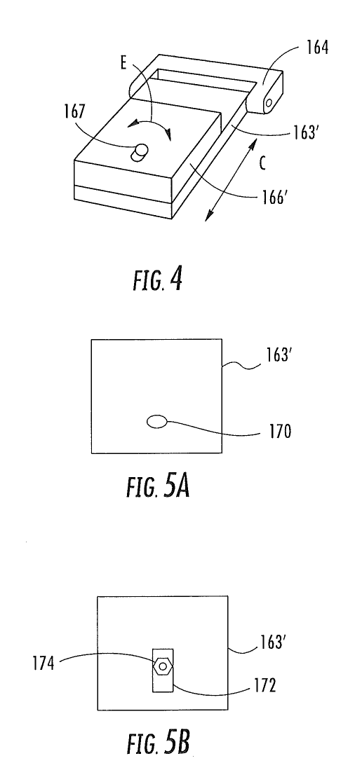

FIG. 5A illustrates the rotatable member 163′ according to some embodiments. As illustrated, the rotatable member 163′ includes an opening 170 (which may be threaded) that is configured to receive the axle 167. The axle 167 may be manipulated (e.g., turned) such that it is released from the opening 170. The mount 166′ may then be rotated in the directions E relative to the rotatable member 163′ (FIG. 4).

The rotatable member 163′ is illustrated in FIG. 5B according to some other embodiments. As shown, the rotatable member 163′ includes an elongated slot 172 that is configured to allow the mount 166′ to be adjusted vertically in the directions C relative to the rotatable member 163′ (FIG. 4). In the illustrated embodiment, a nut 174 extends through at least a portion of the slot 172 and is configured to receive the axle 167. The nut 174 may be friction-fit within the slot 172 such that the mount 166′ may be urged up and down vertically relative to rotatable member 163′. Other configurations are contemplated. For example, the axle 167 may be friction-fit within the slot 172 such that the mount 166′ may be urged up and down vertically relative to the rotatable member 163′. As another example, the rotatable member 163′ may have column of two or more openings (such as the opening 170 shown in FIG. 5A), with each opening configured to receive the axle 167 such that the mount 166′ may be positioned in two or more discrete vertical positions. As yet another example, the rotatable member 163′ may be sandwiched by a pair of layers of the mount 166′ such that the mount 166′ may move up and down relative to the rotatable member 163′ in a telescoping manner.

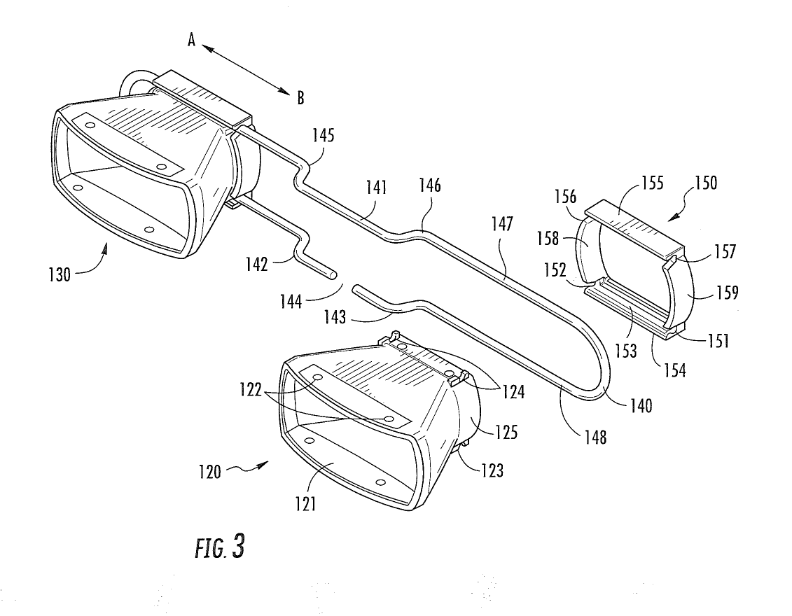

FIG. 3 discloses a partially exploded perspective view of an optical assembly revealing the housing 120 separated from the locking cap 150 and thereby released from the rail frame 140. The rail frame 140 includes at least one top portion 147 and at least one bottom parallel or substantially parallel portion 148 for engaging each side of the housing 120 at or near a viewing end 125 where a user would view into the optical assembly. The rail top portion 147 fits within recesses 124 and the rail bottom portion 148 fits within recesses 123 on the housing 120 that may be secured in place by the locking cap 150 when attached to the housing 120. The locking cap 150 includes complimentary recesses 153 (only one shown on the bottom portion 154) along with slots 151, 152, 156, and 157 to allow traversal of the rail frame 140 past the locking cap sidewalls 158 and 159. The locking cap 150 is adapted to fit over the viewing end 125 of the housing 120 and lock in place around the rail frame 140 as is shown with the optical assembly 130 for the right eye. Such construction allows the optical assembly 130 to be adjusted laterally along the rail frame 140 in directions A and B.

The housing 120 secures a magnifying and/or focusing lens 121, wherein glue holes 122 may be provided for securing the lens 121 in place (particularly when the housing 120 is made of a plastic, polymer, or other synthetic material to maintain the assembly as light as possible).

The rail frame may include bends 142, 143, 145, and 146, a spacer 144, and a forward extending portion 141 to accommodate mounting to the mount 166, 166′ and/or bracket 160.

While the optical assembly 120, 130 may be adapted to slidably engage the rail frame 140 for lateral adjustment thereof, once the optical assembly 120, 130 is in place, a securing mechanism 169 (FIG. 1) may be utilized to maintain the fixed position. In various embodiments, the securing mechanism is any of a screw, clamp, cam lock, tension mechanism, and caliper. The securing mechanism may be incorporated with the housing or locking cap (or both) of the optical assembly. In one embodiment, a tab, button, or similar instrument may be used to engage the securing mechanism with the rail frame for fixed engagement thereto.

It is to be appreciated that any of the elements and features described herein may be combined with any one or more other elements and features.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

That which is claimed is:

1. An optical support assembly comprising:
at least one optical assembly;
a bracket adapted for coupling to a spectacle frame; and
a rail frame coupled to the bracket and comprising any of (1) a rigid rail frame engaged to the at least one optical assembly for laterally adjusting said at least one optical assembly, and (2) a deformable rail frame engaged to the at least one optical assembly for manual reconfiguring said at least one optical assembly.

2. The support assembly of claim 1, further comprising a pivotable member coupled with the bracket for pivoting the rail frame and at least one optical assembly into and away from a viewing position.

3. The support assembly of claim 1, further comprising a rotational adjustment mechanism for rotating the rail frame.

4. The support assembly of claim 3, wherein the rotational adjustment mechanism comprises (a) a mount coupled to the rail frame, and (b) an axle member arranged to (i) traverse an opening in the mount and (ii) couple the mount to the bracket, and wherein the rail frame may be rotated about an axis relatively parallel with the axle member.

5. The support assembly of claim 4, wherein the axle member is a screw adapted to engage threads in the bracket.

6. The support assembly of claim 4, wherein at least a portion of the bracket comprises a slotted throughway adapted to allow traversal of the axle member.

7. The support assembly of claim 1, further comprising a vertical adjustment mechanism integrated with the bracket for vertical movement of the rail frame and the at least one optical assembly.

8. The support assembly of claim 7, wherein the vertical adjustment mechanism comprises (a) a mount coupled to the rail frame, and (b) an axle member arranged to traverse (i) an opening in the mount and (ii) a slotted throughway in at least a portion of the bracket.

9. The support assembly of claim 8, wherein the axle member is a screw, wherein vertical adjustment mechanism further comprises a nut comprising threads adapted to engage the screw, wherein an exterior of the nut is arranged to allow traversal of the nut through the slotted throughway but to inhibit rotational movement of the nut.

10. The support assembly of claim 1, further comprising a securing mechanism for securing the at least one optical assembly in a fixed position on the rail frame.

11. The support assembly of claim 1, wherein the rail frame comprises two substantially parallel rails extending from at least one lateral side of the bracket.

12. The support assembly of claim 1, wherein the optical assembly comprises at least two recesses for slidably engaging the rail frame.

13. The support assembly of claim 1, wherein the optical assembly comprises a housing enclosing at least one lens and a locking cap.

14. The support assembly of claim 13, wherein the locking cap comprises at least two recesses for slidably engaging the rail frame.

15. The support assembly of claim 1, wherein the at least one optical assembly comprises two optical assemblies.

16. A method of adjusting an optical assembly, comprising:
coupling an optical support assembly to a spectacle frame, the optical support assembly comprising (a) at least one optical assembly, (b) a bracket adapted for coupling to a spectacle frame, and (c) a rail frame coupled to the bracket and comprising any of (1) a rigid rail frame engaged to the at least one optical assembly for laterally adjusting said at least one optical assembly, and (2) a deformable rail frame engaged to the at least one optical assembly for manual reconfiguring said at least one optical assembly; and
positioning the at least one optical assembly in a desired disposition relative to the spectacle frame.

17. The method of claim 16, further comprising securing with a securing mechanism the at least one optical assembly in a fixed position on the rail frame.

18. The method of claim 16, further comprising rotating the rail frame with a rotational adjustment mechanism.

19. The method of claim 16, further comprising vertically translating the rail frame and the at least one optical assembly, using a vertical adjustment mechanism.

20. The method of claim 16, further comprising pivoting with a pivotable member the optical assembly into or away from a viewing position, wherein the pivotable member is coupled with the bracket.
